(19) United States
(12) Patent Application Publication
(10) Pub. No.: US 2020/0384388 A1
(43) Pub. Date: Dec. 10, 2020

(54) SELF-CLEANING FILTER

(71) Applicant: CECO ENVIRONMENTAL IP INC., Dallas, TX (US)

(72) Inventor: Jan STUIVER, De Knipe (NL)

(21) Appl. No.: 16/432,706

(22) Filed: Jun. 5, 2019

(51) Int. Cl. B01D 29/66; B01D 29/84; B01D 29/33; B01D 29/52

(52) U.S. Cl. CPC B01D 29/66; B01D 29/52; B01D 29/33; B01D 29/843

(57) ABSTRACT

Embodiments relate generally to a self-cleaning filter. A filter may include a tube comprising perforations. The tube may be configured to receive a flow of a liquid from a first direction or a flow of a gas from a second direction opposite to the first direction. The filter may also include a filter media positioned concentrically around the tube, and spacers positioned between the tube and the filter media to create a space between the tube and the filter media. A portion of the filter media is configured to flex inward into the space during the flow of liquid into the filter, and flex outward from the space during the flow of gas exiting the filter.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Industrial fluid filters may be utilized across various industries such as oil and gas, power generation, water and waste water, battery production, food processing, and chemical processing. For instance, one type of fluid filter includes a vessel with an inlet for receiving a fluid to be filtered and an outlet for discharging a filtered fluid from the vessel.

### SUMMARY

In an embodiment, a filter may include: a tube comprising perforations, the tube configured to receive a flow of a gas from a first direction or a flow of a liquid from a second direction opposite to the first direction; a filter media positioned concentrically around the tube; and spacers positioned between the tube and the filter media to create a space between the tube and the filter media; wherein a portion of the filter media is configured to flex inward into the space during the flow of liquid into the filter, and flex outward from the space during the flow of gas exiting the filter.

In an embodiment, a filter may include: a plurality of tubes, each tube comprising perforations and each tube configured to receive a flow of a gas from a first direction or a flow of a liquid from a second direction opposite to the first direction; and a filter media positioned concentrically around the tubes to form a space between two tubes and a portion of the filter media; wherein the portion of the filter media is configured to flex inward into the space during the flow of liquid into the filter, and flex outward from the space during the flow of gas exiting the filter.

In an embodiment, a method may include: receiving liquid in a vessel including a filter; receiving the liquid in the filter from a first direction, wherein the filter comprises: a tube including perforations; a filter media positioned concentrically around the tube; and spacers positioned between the tube and the filter media to create a space between the tube and the filter media. The method may further include: flexing a portion of the filter media inward into the space upon receipt of the liquid; accumulating filter cake with the filter media; receiving gas into the filter from a second direction opposite to the first direction; and flexing the portion of the filter media outward from the space upon receipt of the gas, to remove the filter cake from the filter media.

In an embodiment, a method may include receiving liquid in a vessel including a filter; receiving the liquid in the filter from a first direction, wherein the filter comprises: a plurality of tubes, each tube comprising perforations; and a filter media positioned concentrically around the tubes to form a space between two tubes and a portion of the filter media. The method may further include flexing the portion of the filter media inward into the space upon receipt of the liquid; accumulating filter cake with the filter media; receiving gas in the filter from a second direction opposite to the first direction; and flexing the portion of the filter media outward from the space upon receipt of the gas, to remove the filter cake from the filter media.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1A illustrates a self-cleaning filter, in accordance with an embodiment of the disclosure.

FIG. 1B is a top view/bottom view of the self-cleaning filter shown on FIG. 1A, in accordance with an embodiment of the disclosure.

FIG. 2A illustrates a self-cleaning filter with a reinforcement core, in accordance with an embodiment of the disclosure.

FIG. 2B is a top view/bottom view of the self-cleaning filter shown on FIG. 2A, in accordance with an embodiment of the disclosure.

FIG. 2C is another view of the self-cleaning filter shown on FIG. 2A, in accordance with an embodiment of the disclosure.

FIG. 2D is a bottom view of the self-cleaning filter shown on FIG. 2A, in accordance with an embodiment of the disclosure.

FIGS. 3A and 3B illustrate flexing of a filter media, in accordance with an embodiment of the disclosure.

FIG. 4A illustrates a self-cleaning filter, in accordance with an embodiment of the disclosure.

FIG. 4B is a top view/bottom view of the self-cleaning filter shown on FIG. 4A, in accordance with an embodiment of the disclosure.

FIG. 4C is another view of the self-cleaning filter shown on FIG. 4A, in accordance with an embodiment of the disclosure.

FIG. 5A illustrates a self-cleaning filter, in accordance with an embodiment of the disclosure.

FIG. 5B is a top view/bottom view of the self-cleaning filter shown on FIG. 5A, in accordance with an embodiment of the disclosure.

FIG. 5C is another view of the self-cleaning filter shown on FIG. 5A, in accordance with an embodiment of the disclosure.

FIG. 6A illustrates a self-cleaning filter with a reinforcement core, in accordance with an embodiment of the disclosure.

FIG. 6B is a top view/bottom view of the self-cleaning filter shown on FIG. 6A, in accordance with an embodiment of the disclosure.

FIGS. 7A and 7B illustrate flexing of a filter media, in accordance with an embodiment of the disclosure.

FIG. 8A illustrates a self-cleaning filter, in accordance with an embodiment of the disclosure.

FIG. 8B is a top view/bottom view of the self-cleaning filter shown on FIG. 8A, in accordance with an embodiment of the disclosure.

FIGS. 8C and 8D illustrate flexing of a filter media, in accordance with an embodiment of the disclosure.

FIGS. 9A-9F illustrate an operation of a self-cleaning filter with a filtrate tube, in accordance with an embodiment of the disclosure.

FIGS. 10A-10F illustrate an operation of a self-cleaning filter without a filtrate tube, in accordance with an embodiment of the disclosure.

### DETAILED DESCRIPTION

The present disclosure relates generally to a self-cleaning filter. A variety of filtration media can be used to filter fluids in various industries that rely on filters to clean fluids. In some industries, filtration assemblies can use discs of filtration media retained by filter plates. The fluid that is being filtered can enter into a central space and flow outwards through the stacked discs of filtration media and filter plates that retain the filtration media in position. When the filtration media is saturated with the components being filtered, the entire filter assembly is removed to allow the filtration media to be replaced. This can entail removing the entire stack of filtration media discs and the filtration plates while the filtration media is saturated with the liquid. This process is time consuming and can expose workers to harmful chemicals. Once the filtration media discs are replaced, the entire assembly can then be replaced for further filtration. The use of filtration media discs results in a large amount of waste. In addition to the components that are filtered from the fluid, the filtration media in the discs is generally discarded as well. When the liquid being filtered is still present in the filtration media discs, there is a loss of potentially valuable liquid as well.

Other filter structures can include filter cartridges in which filtration media is maintained. The media being filtered can be passed through the filtration cartridges, and once saturated, the entire filter cartridges can be removed and discarded. This can generate large amounts of waste that can include the filter cartridge, the component being filtered, and additional fluids retained within the filtration media.

Disclosed herein is a self-cleaning filter assembly that reduces the amount of waste produced by the filter assembly while also reducing the exposure of the workers to the liquid being filtered. The self-cleaning filter may include a filter tube having a filtration media disposed around the filter tube. In some embodiments, a reinforcement core and/or a volume reducer can be disposed within the filter tube to aid in self-cleaning by reducing a volume of a chamber to receive air or another gas to allow for cleaning of the filter media. Due to its configuration, the self-cleaning filter can have a surface area selected to allow a large flow of fluid to enter the self-cleaning filter, where the surface area can be as large as needed for the specific filter design. As the self-cleaning filter assembly is used, the components to be removed from a liquid can form a filter cake on the exterior of the filtration media.

Once the filter cake is to be removed, the filter assembly can be drained of the liquid being filtered. The filter cake can then be dried, thereby further removing the liquid being filtered and reducing the amount of material that is disposed of from the filter. The filter assembly can then be back-pulsed with gas to remove the filter cake. As described in more detail below, the shape of the filter tube can be selected through various designs to have a non-smooth surface. The filtration of the fluid and formation of the filter cake can then result in a non-round shape that can be expanded by the back-pulsing of gas. The expansion can result in the dried filter cake dislodging from the filtration media breaking off of and fall from the filtration media, thereby cleaning the filtration media. The dried filter cake can then be collected and disposed of separately from the filtration media, which can be reused. This system reduces the total volume of waste, while also allowing for the removal of the components removed from the fluid without the need for workers to handle the removed components directly.

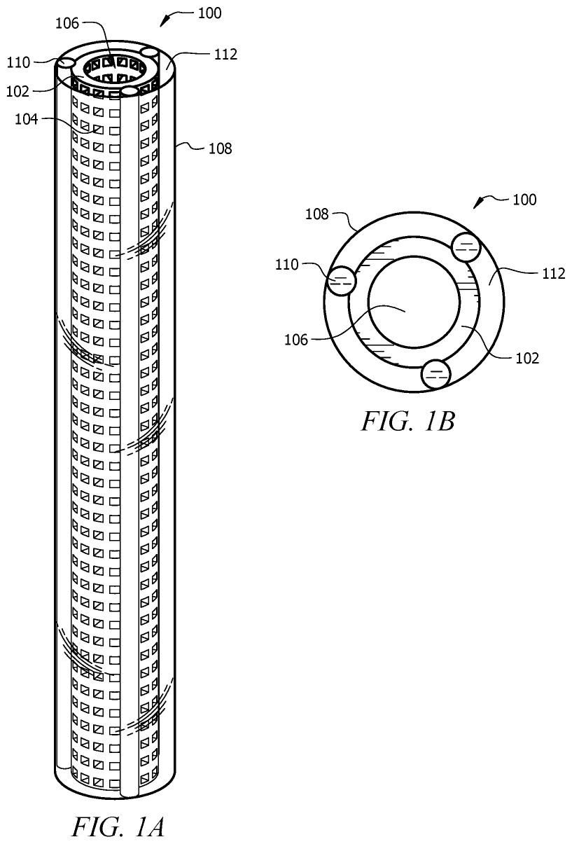

FIGS. 1A and 1B illustrate a self-cleaning filter 100 with a single tube 102 (“tube 102”). The tube 102 serves as a structural support for the filter media 108. For example, when fluid flows from outside of the filter media 108 into the center of the tube 102, the tube 102 holds the flexible filter media 108 and retains the filter media 108 in position while the fluid is filtered. The tube can have a plurality of openings or perforation 104 to allow fluid to flow into the center of the tube 102. The perforations 104 are flow passages that may be arranged in columns and rows. While shown as a tube 102 having a round cross section, the tube can have other cross-sectional shapes depending on the use of the filter and the filtering conditions.

The tube 102 can have any suitable diameter and length. The size of the tube 102 can be selected to provide a filtering area, which based on the type of filter media 108, suitable for the use for filtering a type and flow rate of fluid. In some embodiments, the tube 102 may have a length ranging from about 250 millimeters (mm) to about 3000 mm, or between about 500 mm and about 2000 mm. In some embodiments, a radius, r, of tube 102 may range from about 8 mm to about 120 mm, or from about 16 mm to about 80 mm.

The tube 102 may be made of any suitable material that has the proper structural strength and/or is inert to the fluids being filtered. In some embodiments, the tube 102 can be made of metals or alloys (e.g., steel, stainless steel, etc.), a composite material, polymers (e.g. polypropylene, polyvinylidene fluoride (PVDF), etc.), polymer coated or lined metal (e.g., a rubber lined vessel), or the like. In some embodiments, the tube 102 can be formed from a plastic such as polypropylene. When the tube 102 is formed from plastic, as may be needed when working with certain fluids such as corrosive solutions, the structural strength of the material can be an issue. This can create unique challenges for the designs of the self-cleaning filter 100 and the tube 102 based on certain factors such as when the size of the tube 102 is increased, the operating temperature increases, and/or the pressure differentials increases. The configurations of the filters as disclosed herein can then be used to allow for the filters to be scaled up while still maintaining the structural integrity needed for various operating conditions.

The central opening in the tube can define a chamber 106 positioned within tube 102, where the chamber 106 can be in fluid communication with perforations 104. The chamber 106 may extend along the length of tube 102. The chamber 106 serves as a fluid passageway for fluids during filtering and cleaning, where the chamber may fill with filtered liquid during operation of self-cleaning filter 100 and a gas during cleaning of the self-cleaning filter 100.

The filter media 108 may be positioned concentrically about/around the tube 102 and may extend along the length of the tube 102. The filter media 108 serves to remove one or more materials within a fluid flow as the fluid flows through the filter media 108. The filter media 108 may be a flexible material capable of being formed into tubes, sheets, and/or rolls. Examples of such materials can include, but are not limited to, paper, polypropylene, cellulose, polytetrafluoroethylene, tetrafluoroethylene, and other synthetic materials. The porosity and/or thickness of the filter sheet may be selected depending on the materials desired to be removed from the fluid. Examples of porosities may range from about 0.5 micron to about 200 microns. Examples of thicknesses of the filter media 108 may range from about 0.5 millimeter (mm) to about 3 millimeter. A surface area of the filter media 108 may range from about 0.05 to about 0.8, or from about 0.1 to about 0.5 meters squared (m²) per meter-length of the filter media along an axial direction of the tube 102. The filter media 108 (and filter 100) may be configured to receive fluid to be filtered at a flow rate ranging from 0 cubic meters per hour (m³/h) to 200 m³/h, or up to about 125 m³/h. The filter media 108 can have a diameter that is slightly larger than that of the tube 102 to allow the filter media to be placed over the tube 102 and any spacers 110. In some embodiments, the filter media 108 can have a diameter between about 40 mm and about 250 mm, or from about 50 mm to about 210 mm.

One or more spacers 110 can be positioned around the tube 102 and between the filter media 108 and the tube 102. The spacers 110 serve to shape the filter media 108 during use while allowing the filter media 108 to expand during a cleaning cycle of the self-cleaning filter 100. The presence of additional material made by the filter media may allow for a void or space 112 to be formed between the tube 102 and the filter media 108 due to the presence of spacers 110 during cleaning cycle. During filtering, the spacers 110 allow filter media 108 to deform inward (during a flow-in of liquid to be filtered) into space 112. During this process, a filter cake or layer can be formed on an outside of the filter media 108. In some embodiments, the filter media 108 may adhere/stick to tube 102 during the in-flow of the liquid to be filtered. During the in-flow, filter cake may form on filter media 108. In order to remove this filter cake, the filter media 108 may be popped/pushed outward quickly with a gas flow during the flow-out to remove or break off filter cake that has accumulated and adhered to filter media 108, as described in more detail herein.

In some embodiments, the spacers 110 may be in the form of rods and extend along the length of tube 102 and filter media 108. While shown as having a round cross-section, the spacers 110 can also have other cross-section shapes such as half-circle, triangular, square, or the like. In some embodiments, the spacers can have a diameter in a range from about 5 mm to about 40 mm, or from about 10 mm to about 25 mm. In some embodiments, a ratio of the diameter, s, of each spacer 110 to the inner diameter of the tube 102 may range from about 0.06:1 to about 0.9:1, or between about 0.06:1 to about 0.8:1. Any suitable number of spacers can be used around the tube 102. Spacers 110 may be made of a material that is suitable for the environment in which the filter is used such as metal, polymers (e.g. polypropylene, polyvinylidene fluoride (PVDF), etc.), polymer coated or lined metal (e.g., a rubber lined vessel), or the like. In some embodiments, the spacers 110 can be formed from any of the materials used to form the tube 102, and in some embodiments, the spacers can be formed using the same materials as the tube 102.

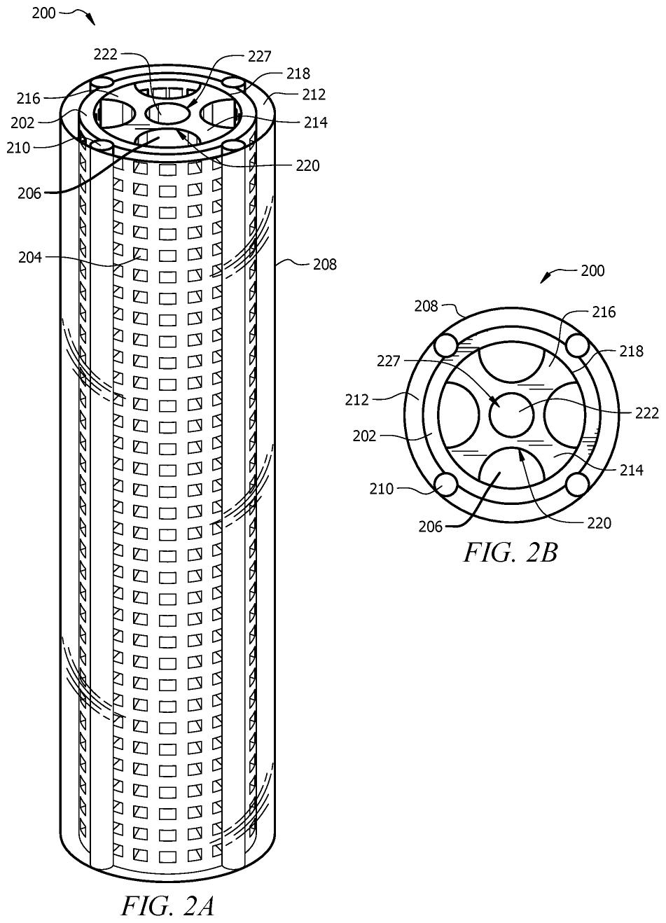

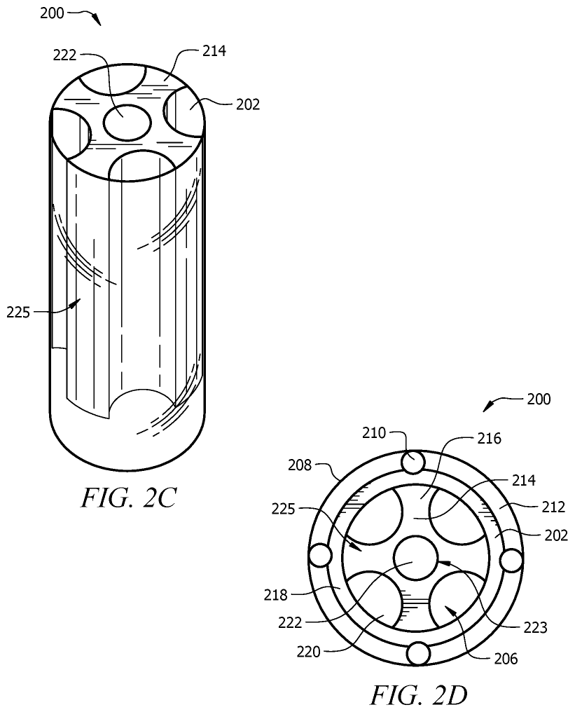

FIGS. 2A-2D illustrate a self-cleaning filter 200 with a single tube 202 (“tube 202”). The tube 202 may be the same or similar to the tube described with respect to FIGS. 1A and 1B, and the size and materials can be used with tube 202. The self-cleaning filter 200 can be similar to the self-cleaning filter 100, with the exception of the presence of a reinforcement core 214 and/or additional spacers 210, and like components can be the same or similar to those described with respect to the self-cleaning filter 100.

A chamber 206 may be formed and defined by an inner surface of the tube 202 and an outer surface of the reinforcement core 214. The chamber 206 is in fluid communication with the perforations 204 within the tube 202. The chamber 206 may include free space/volume within the tube 202 that is not occupied by a reinforcement core 214. The chamber 206 may extend along the length of tube 202, and may fill with filtered liquid during a filtering operation of self-cleaning filter 200. In some embodiments, the reinforcement core 214 may reduce the interior volume of the tube 202 by an amount of at least about 10%, 20%, 30%, 40%, or 50%. In some embodiments, the reinforcement core 214 may reduce the interior volume of the tube 202 by an amount of equal to or less than 99%, 95%, 90%, 80%, or 70%. In some embodiments, the reinforcement core 214 may reduce the interior volume of the tube 202 by an amount between any of the lower amounts and any of the upper amounts.

The filter media 208 may be positioned concentrically about/around tube 202 and may extend along the length of tube 202. The filter media 208 can include any of the filter media described with respect to the self-cleaning filter 100. A surface area of the filter media 108 may range from about 0.05 to about 0.8, or from about 0.1 to about 0.5 meters squared (m²) per meter-length of the filter media along an axial direction of the tube 102. The filter media 108 (and filter 100) may be configured to receive fluid to be filtered at a flow rate ranging from 0 cubic meters per hour (m³/h) to 200 m³/h, or up to about 125 m³/h.

As with the filter media 208, the spacers 210 can be the same or similar to the spacers 110, and any of the spacers described with respect to the self-cleaning filter 100 can be used with the self-cleaning filter 200. Similarly, the tube 202 can be the same or similar to the tube 102, including any of the materials of construction and sizes as described above.

As shown, the self-cleaning filter 200 can include a reinforcement core 214. The reinforcement core 214 can serve a number of functions including helping to reduce the total volume of the chamber 206 as well as providing reinforcement within the tube 202 to provide structural support during use in a filtering process. The reinforcement core 214 (“core 214”) may be made of any suitable material, including those that are inert to the fluid being filtered. In some embodiments, the reinforcement core 214 can be formed from metals or alloys (e.g., steel, stainless steel, etc.), a composite material, polymers (e.g. polypropylene, polyvinylidene fluoride (PVDF), etc.), polymer coated or lined metal (e.g., a rubber coated materials), or the like. The reinforcement core 214 may be positioned concentrically within tube 202 and may extend partially or entirely along the length of tube 202, as shown on FIG. 2C.

In some embodiments, the reinforcement core 214 may be positioned within the chamber 206 to reduce the volume or free space within the chamber 206. A reduction in the amount of free space in the chamber 206 can reduce the amount and/or volume of a gas needed to expand the filter media during a cleaning process, as described in more detail herein.

The reinforcement core 214 may also include support portions 216 that extend outwards from the center of the tube 202 and contact the interior of the tube 202 to support tube 202 (e.g., prevent deformation of tube 202 during in-flow (filtering) of liquid or out-flow-out (e.g., self-cleaning) of gas). The support portions 216 and the spacers 210 can have any relative alignments around the perimeter of the tube 202. In some embodiments, the segments 218 of tube 202 may be positioned between support portions 216 and spacers 210, such that the segments 218 can be radially aligned with the spacers 210. This configuration may allow the spacers 210 to be supported by the segments 218 during use. However, this alignment is optional and not necessary in all embodiments

The reinforcement core 214 may include recessions 220 positioned between the support portions 216. The recessions 220 may extend lengthwise along the reinforcement core 214 and may provide fluid flow pathways that fill with filtered liquid as liquid passes through the filter media 208 and the perforations 204. Also, the reinforcement core 214 may include a central passage 222 extending lengthwise through a center of the reinforcement core 214. During use, the filtered liquid can enter the passage 222 via an inlet 223 positioned at an end 225 (a bottom) of the reinforcement core 214, as shown on FIGS. 2C and 2D. After the filtered fluid enters the passage 222, the filtered fluid may exit the passage 222 via an outlet 227 into a receptacle for filtered fluid, as shown on FIG. 2B.

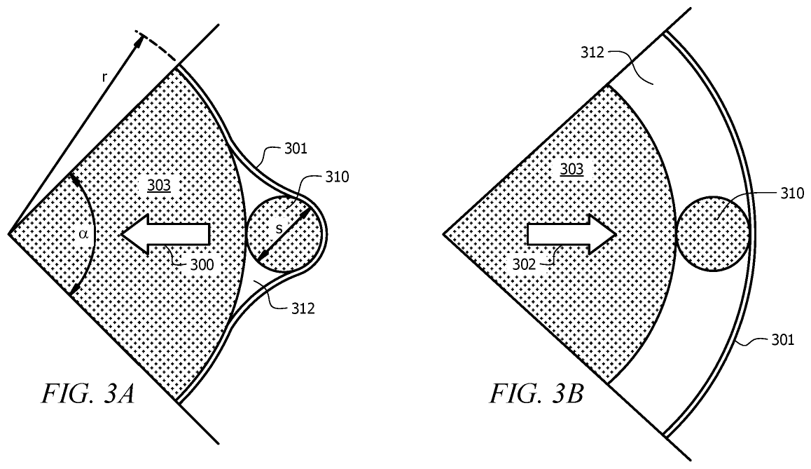

FIG. 3A illustrates a top view of a filter media 301. The filter media 301 may be a particular embodiment of the filter media 108 or the filter media 208 during the flow-in period (filtering period). As shown, as a fluid enters the filter media 301 from an exterior of the self-cleaning filter and into the interior of the tube, the filter media 301 moves/flexes inward due to the flow/pressure of the fluid being filtered, and the filter media 301 may contact and be biased towards an outside surface of tube 303 and/or spacer 310 that may include the tube 102 or 202, as shown. A space 312 can be formed between the spacer, the exterior surface of the tube, and the inner surface of the filter media 301. The flow of entering fluid during a filtering process is depicted by the arrow 300. The spacer 310 may be a particular implementation of the spacer 110 or the spacer 210. The space 312 may be a particular implementation of space 112 or 212.

FIG. 3B illustrates a top view of filter media 301 during the out-flow period (e.g., during a self-cleaning period or process) after the in-flow period shown on FIG. 3A. In this process, a gas can be introduced into an interior of the tube and flow outwards through the filter media. As shown, as a gas (e.g., a purging gas, a cleansing gas, etc.) pressurizes the filter media 301, the filter media 301 moves/flexes outward from the space 312 (due to the flow/pressure of the gas exiting the tube) and may rebound or move back substantially to a pre-filtering/initial physical form. The flow of exiting gas is depicted by the arrow 302. The self-cleaning period allows for the gas to exit filter media the tube, thereby flexing (in an outward direction) the filter media 301. This flexing results in a removal/dropping of any filter cake that has formed on and/or adhered to filter media 301.

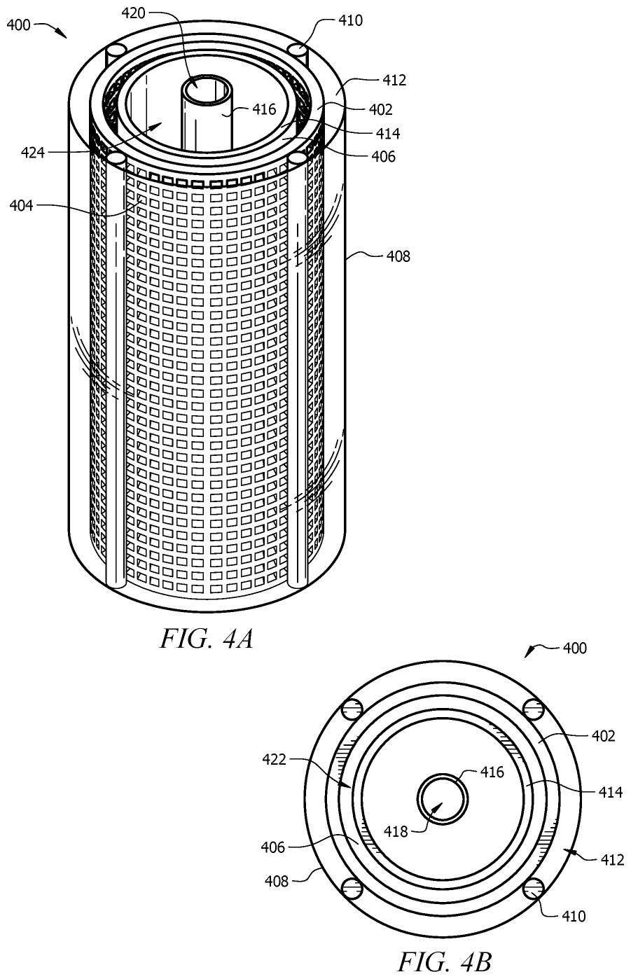

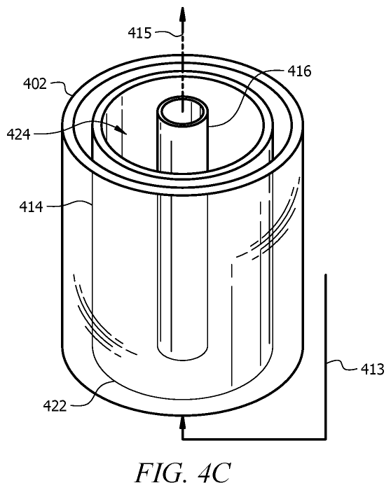

FIGS. 4A and 4B illustrate an embodiment of a self-cleaning filter 400 with a single tube 402 (“tube 402”). The self-cleaning filter 400 is similar to the self-cleaning filters 100 and 200, and similar components can be the same or similar to the components described with respect to the self-cleaning filters 100 and 200. The main difference between the self-cleaning filter 400 and the self-cleaning filters 100 and 200 is the volume reducer 414.

The tube 402 may be the same or similar to the tubes described with respect to the self-cleaning filters 100 and 200. In some embodiments, the tube 402 may have a length ranging from about 250 millimeters (mm) to about 3000 mm, or between about 500 mm and about 2000 mm. In some embodiments, a radius, r, of tube 402 may range from about 50 mm to about 300 mm, or from about 60 mm to about 200 mm. The tube 402 may be perforated as described with respect to the tubes described with respect to the self-cleaning filters 100 and 200.

The chamber 406 can be defined by an inner surface of the tube 402 and formed within tube 402. The chamber 406 is in fluid communication with an exterior of the tube 402 and filter media 408 via the perforations 404. The chamber 406 may extend along the length of the tube 402, and may include free or unoccupied space within the tube 402.

The filter media 408 can be the same as the filter media described with respect to the self-cleaning filter 100 or the self-cleaning filter 200. The filter media 408 may be positioned concentrically about/around tube 402 and may extend along the length of tube 402. The filter media 408 can have a diameter that is slightly larger than that of the tube to allow the filter media to be placed over the tube 402 and any spacers 410. In some embodiments, the filter media 408 can have a diameter between about 150 mm to about 500 mm, or from about 165 mm to about 480 mm. A surface area of the filter media 408 may range from about 0.2 to about 1.5, or from about 0.4 to about 1.3 meters squared (m²) per meter-length of the filter media along an axial direction of the tube 402. The filter media 408 may be configured to receive fluid to be filtered at a flow rate ranging from 0 cubic meters per hour (m³/h) to 200 m³/h, or up to about 125 m³/h.

The spacers 410 can be the same as the spacers described with respect to the self-cleaning filter 100 or the self-cleaning filter 200. In some embodiments, the spacers 410 can have a diameter in a range from about 10 mm to about 60 mm, or from about 20 mm to about 40 mm. In some embodiments, a ratio of the diameter, s, of each spacer 110 to the inner diameter of the tube 102 may range from about 0.03:1 to about 0.8:1, or between about 0.05:1 to about 0.5:1

As shown, the self-cleaning filter 400 can include a volume reducer 414. The volume reducer 414 is similar to the reinforcement core described herein in that the volume reducer 414 serves to reduce the volume within the chamber 406. The volume reducer 414 may be of a cylindrical shape and may partially or fully extend along the length of tube 402, similar to the reinforcement core 214 as shown on FIG. 2C. The volume reducer 414, similar to the reinforcement core 214, also reduces a volume of free space that can be occupied by a fluid. The volume reducer 414 may include a passage 416 passing therethrough. In some embodiments, the volume reducer 414 may reduce the interior volume of the chamber 406 by an amount of at least about 10%, 20%, 30%, 40%, or 50%. In some embodiments, the volume reducer 414 may reduce the interior volume of the chamber 406 by an amount of equal to or less than 99%, 95%, 90%, 80%, or 70%. In some embodiments, the volume reducer 414 may reduce the interior volume of the chamber 406 by an amount between any of the lower amounts and any of the upper amounts.

In use of the self-cleaning filter 400, liquids containing contaminants can pass through filter media 408 from an exterior of the self-cleaning filter 400 into an interior of the tube 402 via the perforations 404 of tube 402, thereby filtering at least a portion of the contaminants as the fluid passes through the filter media 408. The filtered fluid can pass between the interior of the tube 402 and an exterior of the volume reducer 414 (see the arrow 413 in FIG. 4C). The filtered liquid can then enter (see the arrow 413) the passage 416 (e.g., a tube) via an inlet 418 (see FIGS. 4B and 4C). The filtered liquid may then pass through the passage 416 and can exit (see arrow 415) passage 416 via an outlet 420, which can be in fluid communication with a receptacle for holding the filtered liquid. The end 422 (bottom end) of the volume reducer 414 may be sealed except for the inlet 418 and the passage 416. A space 424 (internal bore or internal chamber) within an interior of the volume reducer 414 and around/about passage 416 can be arranged with a filter housing using appropriate seals and the like to remain free of any liquid. This allows for a reduction in a volume/free space within tube 402.

As shown in FIGS. 4A-4C, the volume reducer 414 is placed within the tube 402, but may not contact an inner surface of the tube 402. The volume reducer 414 can be retained in position by one or more components of a filter housing, as described in more detail herein. Appropriate seals and connections can be present as part of the filter housing to allow the fluid to flow along predetermined flow pathways.

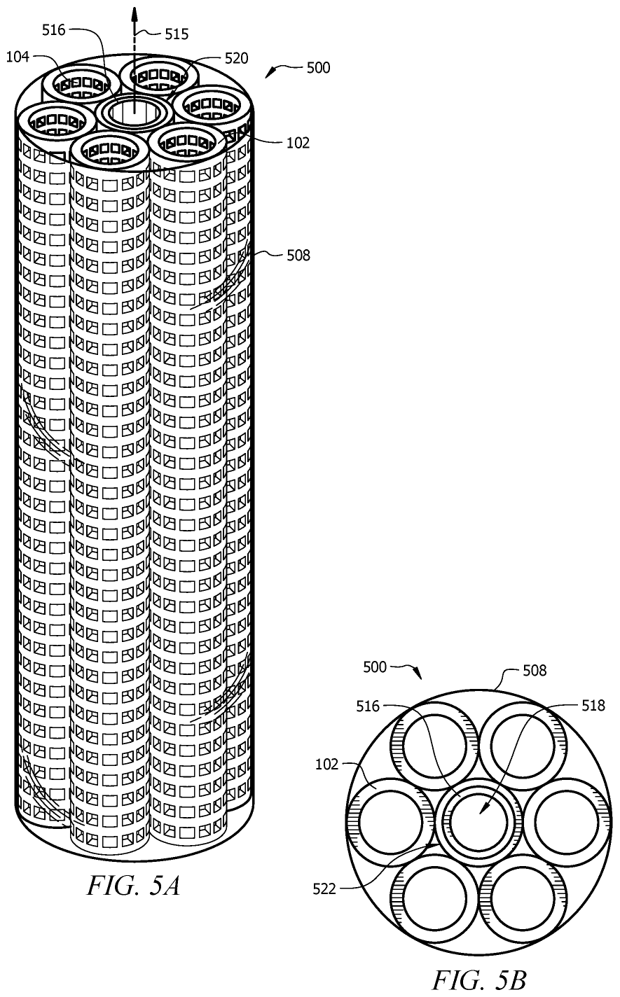

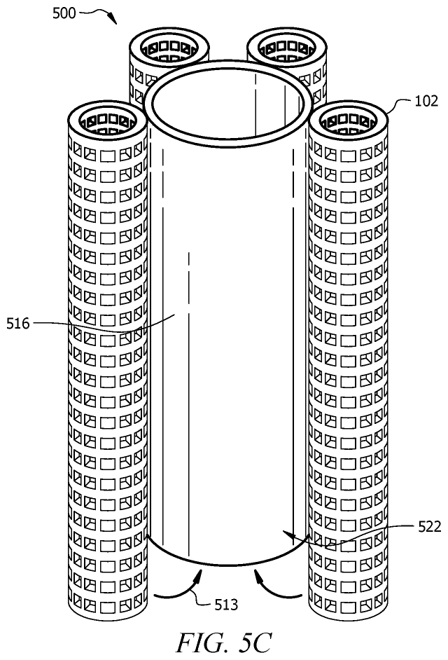

FIGS. 5A-5C illustrate self-cleaning filter 500 with multiple tubes 102, as described above (see FIGS. 1A and 1B). The self-cleaning filter 500 has components similar to those described with respect to the self-cleaning filters 100, 200, 400, and the same or similar components may have the same reference numbers. In some embodiments, multiple tubes 102 (e.g., a plurality of tubes 102) may be positioned about or around a passage 516 through a flow tube. The flow tube 516 may extend partially along the length of the tubes 102, as shown on FIG. 5C. In some embodiments, the flow tube 516 can extend along the entire length of the tubes, and one or more opening can be disposed in an end of the flow tube 516 to provide a fluid pathway into an interior of the flow tube 516. The use of multiple tubes 102 may provide the spacing to allow the filter media to contract and expand in response to the filtering process and cleaning process. As shown, the multiple tubes 102 may take the place of spacers in this embodiment as the outer profile of the tubes 102 serves as the spacers.

When multiple tubes 102 are present, the filter media 508 may be positioned concentrically about/around the tubes 102 and may extend along the length of the tubes 102. In some embodiments, the tube 102 may have a length ranging from about 250 millimeters (mm) to about 3000 mm, or between about 500 mm and about 2500 mm. In some embodiments, a radius, r, of tube 102 may range from about 8 mm to about 80 mm, or from about 10 mm to about 65 mm.

The filter media 508 may be the same or similar to any of the filter media as described herein. In some embodiments, the filter media 508 (and filter 500) may be configured to receive fluid to be filtered at a flow rate ranging from 0 m³/h to 150 m³/h. A surface area of the filter media 508 may range from about 0.05 to about 1.5, or from about 0.1 to about 1.2 meters squared (m²) per meter-length of the filter media along an axial direction of the tube 102. The filter media 508 can have a diameter that is slightly larger than that of the tube to allow the filter media to be placed over the plurality of tubes 102. In some embodiments, the filter media 508 can have a diameter between about 40 mm to about 500 mm, or from about 50 mm to about 375 mm.

During a filtering process, contaminated liquid can pass through from an exterior of the self-cleaning filter 500, through the filter media 508, and through the perforations 104 of tubes 102 and/or into a space between the tubes 102 and an exterior of the flow tube 516. The filtered liquid can pass to an end of the flow tube 516 and enter (see arrows 513) the interior of the flow tube 516 via an inlet 518, as shown on FIGS. 5B and 5C. In some embodiments, the flow tube 516 can extend the entire length of the tubes 102, and one or more openings can be present to allow the filtered fluid to enter the interior of the flow tube 516. The filtered liquid may then pass through the flow tube 516 and exit (see arrow 515) the flow tube 516 via an outlet 520, which can be in fluid communication with a receptacle or flow pathway for holding the filtered liquid. FIG. 5B illustrates the end 522 (bottom end) of the flow tube 516. The self-cleaning filter 500 can be retained in position within a filter housing by one or more components of a filter housing, and appropriate seals and connections can be present as part of the filter housing to allow the fluid to flow along predetermined flow pathways.

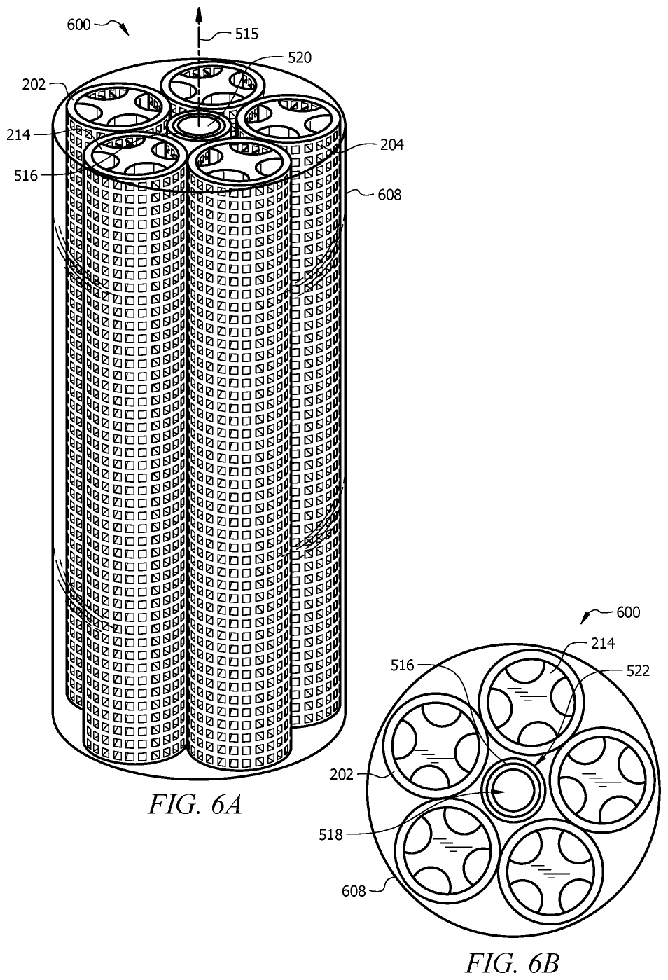

FIGS. 6A and 6B illustrate a self-cleaning filter 600 with multiple tubes 202 including cores 214. The cores 214 can be the same or similar to the cores 214 described above (see FIGS. 2A and 2B). Further, the self-cleaning filter 600 having multiple tubes can be the same or similar to the self-cleaning filter 500 as described with respect to FIGS. 5A-5C, and similar components can be the same or similar. The filter media 608 may be positioned concentrically about/around tubes 202 and may extend along the length of tubes 202. The filter media 608 may be the same or similar to any of the filter media as described herein, including filter mediate 508. The cores 214 can be positioned within one or more of the tubes, and in some embodiments, all of the tubes 202. The cores 214 can serve to support the tubes 202 and/or reduce the interior volume within the tubes 202.

During a cleaning process, a liquid containing one or more contaminants to be filtered can pass through filter media 608 to remove at least a portion of the one or more contaminants. When being used for filtering the fluid, the filter media 608 can contact and conform to the outer surface of the tubes 202. The filtered liquid can pass into the tubes 202 via perforations 204 and/or into the space between the tubes and the flow tube 516. The filtered liquid can then enter the flow tube 516 via an inlet 518. The filtered liquid may then exit the flow tube 516 via an outlet 520, which can be in fluid communication with a receptacle for holding the filtered liquid. FIG. 6B illustrates the end 522 (bottom end) of the flow tube 516. The flow of liquid in this configuration is similar to the flow of liquid shown on FIGS. 5A-5C.

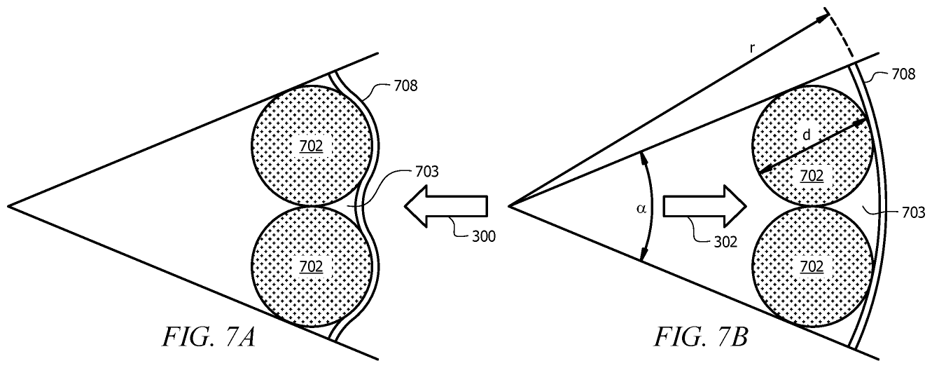

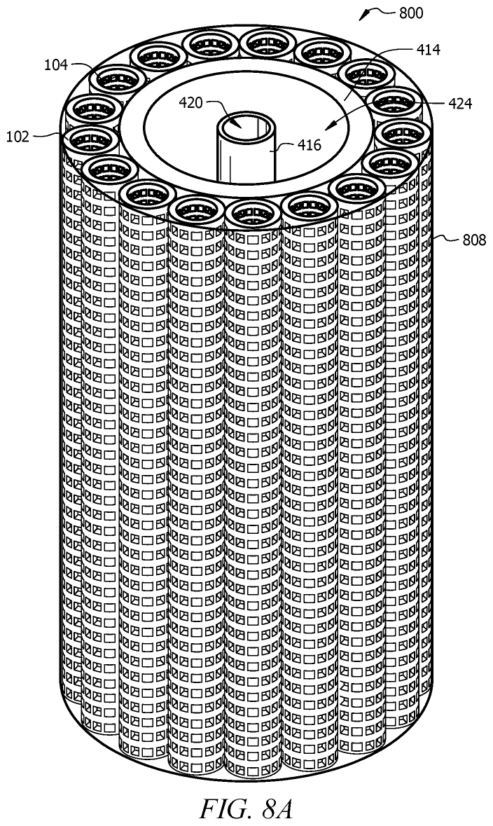

FIG. 7A illustrates a top, cross-section view of filter media 708. Filter media 708 may be a particular implementation of filter media 508 or 608 during the in-flow period or process, and the filter media 708 can include any of the filter media materials as described herein. As shown, as a fluid enters filter media 708, filter media 708 moves/flexes inward into space 703 due to flow/pressure of the fluid being filtered and may conform to and engage an outside surface of tubes 702 that may include tubes 102 or 202, as shown. The direction of flow of the entering fluid is depicted by arrow 300.

FIG. 7B illustrates a top, cross-sectional view of filter media 708 during the out-flow period (e.g., filter self-cleaning period). As shown, as a gas (e.g., a purging/cleansing gas) exits filter media 708, filter media 708 moves/flexes outward from space 703 due to flow/pressure of the exiting gas and move back substantially to a pre-filtering/initial physical form. The force to move the filter media 708 back to the initial form can be provided by the pressure drop across the filter media supplied by the gas. The flow direction of exiting gas is depicted by arrow 302 in FIG. 7B. The self-cleaning period allows for the gas to exit filter media 708, thereby flexing (in an outward direction) filter media 708. This flexing can result in a removal of at least a portion of any filter cake that has adhered to filter media 708. The removal process can be enhanced by first drying the filter cake, as described in more detail herein.

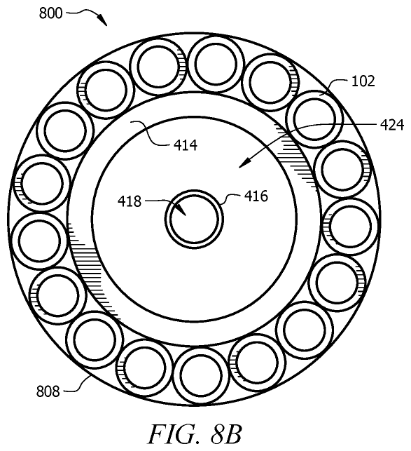

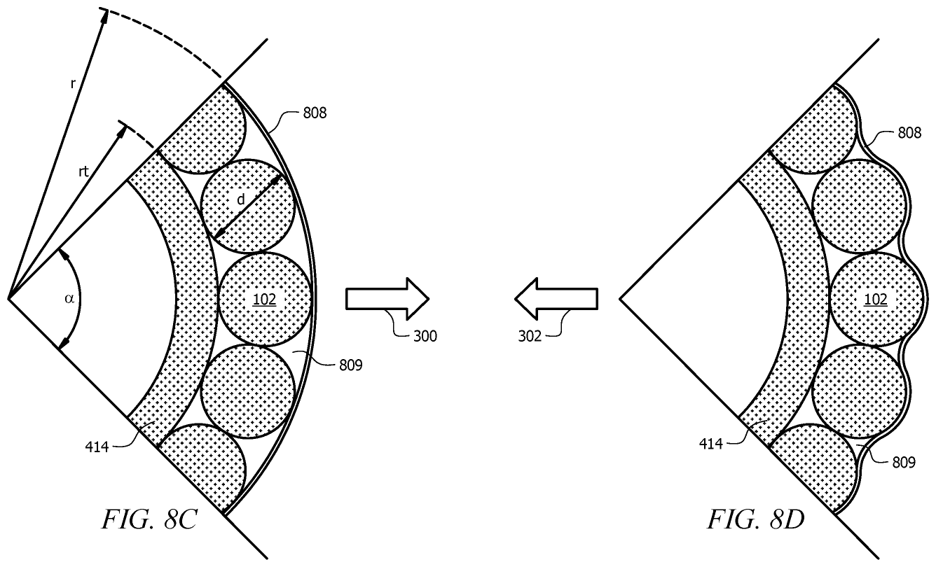

FIGS. 8A and 8B illustrate an embodiment of a self-cleaning filter 800 with multiple tubes 102 and a volume reducer 414. The components of the self-cleaning filter 800 can be the same or similar to those described herein, for example as described above (e.g., see FIGS. 1A, 1B, 4A, 4B, and 4C). In some embodiments, the tube 102 may have a length ranging from about 250 millimeters (mm) to about 3000 mm, or between about 500 mm and about 2500 mm. In some embodiments, a radius, r, of tubes 102 may range from about 5 mm to about 60 mm, or from about 10 mm to about 45 mm. A surface area of the filter media 808 may range from about 0.2 to about 3, or from about 0.4 to about 2.25 meters squared (m²) per meter-length of the filter media along an axial direction of the tube 102. The filter media 808 may be configured to receive fluid to be filtered at a flow rate ranging from 0 cubic meters per hour (m³/h) to 300 m³/h, or up to about 250 m³/h. The filter media 808 can have a diameter that is slightly larger than that of the tube to allow the filter media to be placed over the tubes 102. In some embodiments, the filter media 808 can have a diameter between about 100 mm to about 750 mm, or from about 130 mm to about 680 mm.

In use, a liquid comprising one or more contaminants can pass through the filter media 808 from an exterior of the self-cleaning filter 800 into the one or more tubes 102 and/or a space between the one or more tubes 102 and an exterior of the volume reducer 414 via the perforations 104 of the tubes 102. The filtered liquid enters the flow tube 416 via an inlet 418, shown on FIGS. 4B and 4C. The filtered liquid may then exit (see arrow 415 in FIG. 4C) the flow tube 416 via an outlet 420, which can be in fluid communication with a receptacle for holding the filtered liquid. The end 422 (bottom end) of the volume reducer 414 may be sealed except for the inlet 418 the flow tube passage 416. The space 424 within the volume reducer 414 and around/about the flow tube 416 can remain free of any liquid based on being retained in a filter housing. This allows for a reduction in a volume/free space within the self-cleaning filter 800.

FIG. 8C illustrates a top view of filter media 808 during an out-flow period (filter self-cleaning period) after an in-flow period shown on FIG. 8D. As shown, as a gas (purging/cleansing gas) exits filter media 808, filter media 808 moves/flexes outward from space 809 due to flow/pressure of the gas exiting and may rebound or move back substantially to a pre-filtering/initial physical form. The flow of exiting gas is depicted by arrow 302. The self-cleaning period allows for the gas to exit the filter media 808, thereby flexing in an outward direction the filter media 808. This flexing can result in a removal of at least a portion of any filter cake that has adhered to filter media 808.

FIG. 8D illustrates a top view of a filter media 808 during the flow-in period (filtering period). As shown, as a fluid enters filter media 808, filter media 808 moves/flexes inward into space 809 due to flow/pressure of the fluid being filtered and may conform to an outside surface of tubes 102, as shown. The flow of entering fluid is depicted by arrow 300.

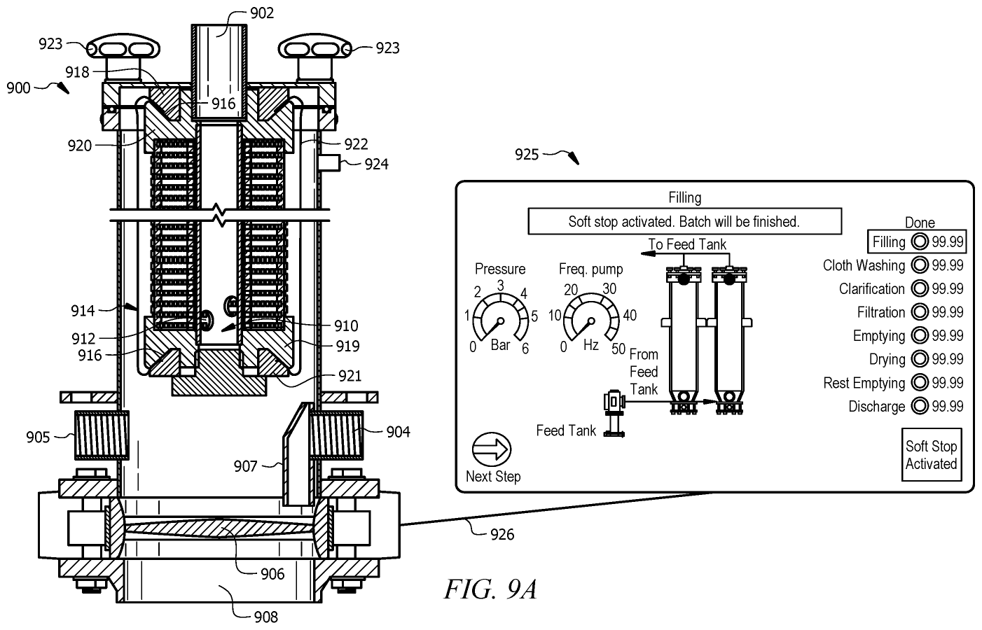

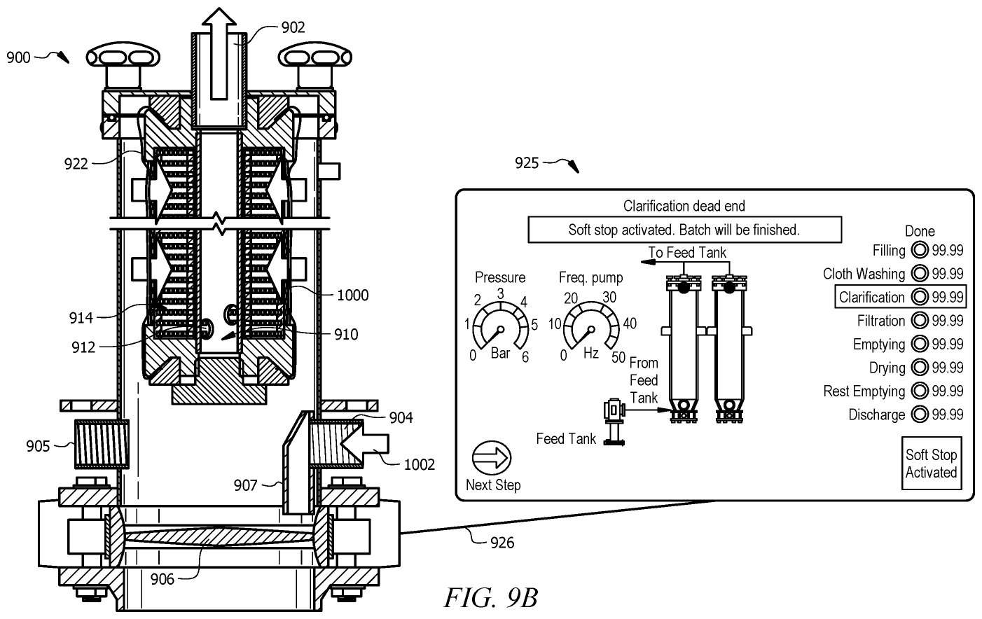

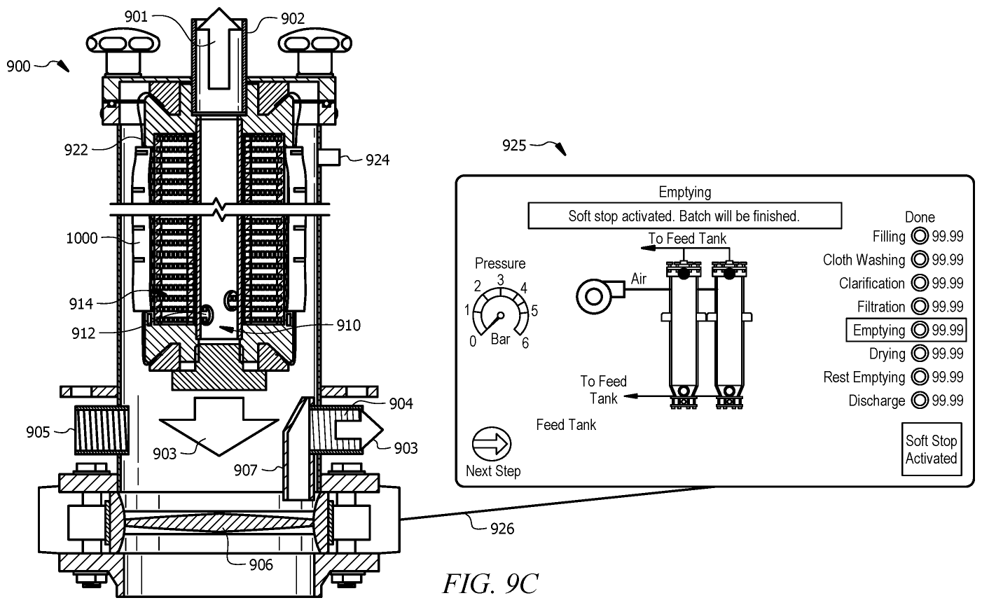

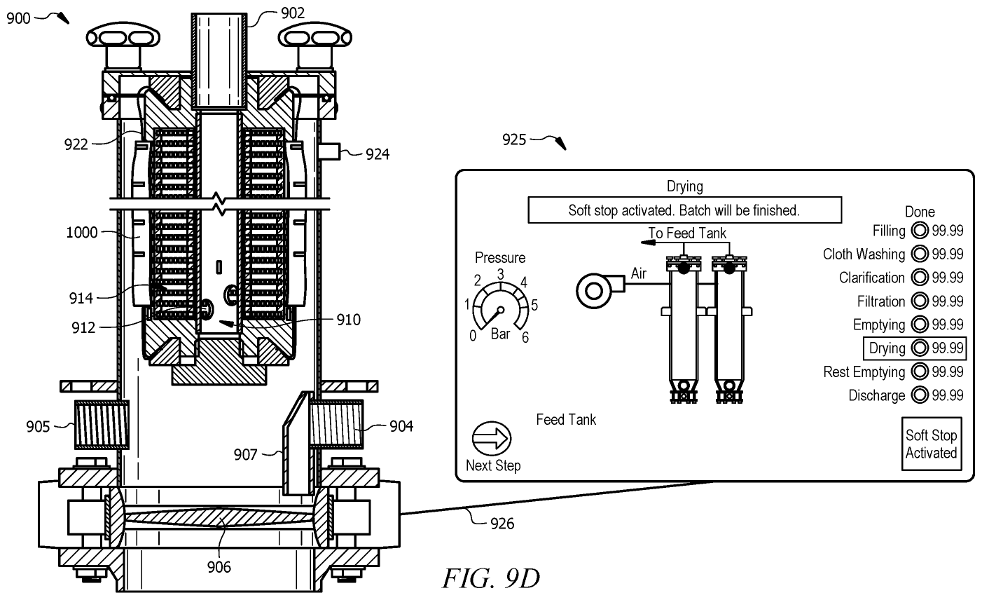

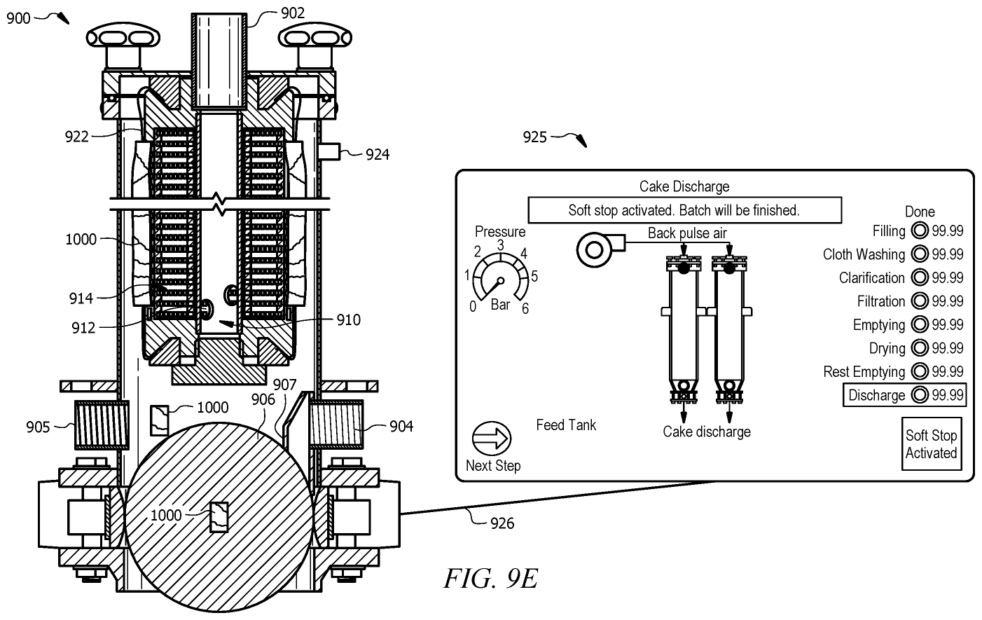

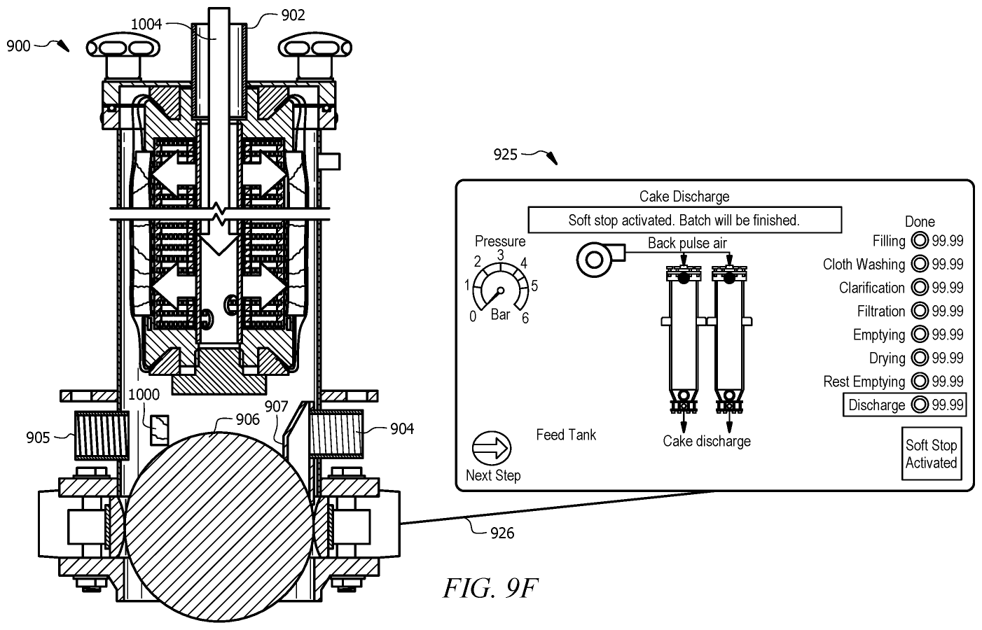

FIG. 9A illustrates a filtering vessel 900. The vessel 900 is configured to contain a self-cleaning filter element as described above. The vessel 900 may be a container configured to withstand high pressures and high temperatures during filtering operations. The vessel 900 may be a sealed/pressurized vessel. Depending on the operating conditions, the vessel 900 can be constructed of a suitable material capable of withstanding the temperatures, pressures, and chemicals encountered in a filtering process.

In some embodiments, the vessel 900 may include a filtrate outlet 902 (“outlet 902”), which can be or can be fluidly coupled to, a valve at a first end (top) of the vessel 900, a feed inlet 904, which can be or can be fluidly coupled to, a valve at a second end (bottom), and a filter cake disposal valve 906. A filter cake discharge chute 908 may be adjacent to the disposal valve 906. The vessel 900 may include a filter 914 that may be a particular implementation of a filter as discussed above (e.g., filter 200, 500, 600, or 800). The vessel 900 may also include filtrate flow tube 910 (“flow tube 910”) to receive filtered liquid via one or more inlets 912. The flow tube 910 may be a particular implementation of any of the embodiments of a core or a volume reducer as described herein. It should be noted that the flow tube 910 may include inlets 912 (e.g., side inlets in FIG. 9A) or inlet 223 (e.g., bottom inlet in FIG. 2D) or 418 (e.g., bottom inlet in FIG. 4B).

In some embodiments a drain tube 907 can be present within the filtering vessel 900. The drain tube 907 can be coupled to the feed inlet 904 and provide a sealed fluid pathway between the feed inlet 904 and a lower portion of the filtering vessel 900 above the disposal valve 906. The drain tube 907 allows the fluid within the filtering vessel 900 to be nearly completely drained from the filtering vessel 900 during a drying a filter cleaning process, as described in more detail herein. A second feed inlet 905 can be optionally present in the vessel 900 for use as a feed inlet or a drain outlet. The second inlet 905 may be useful for high flow operations where additional flow rate into and/or out of the vessel 900 is needed.

The filter can be retained within the vessel 900 using various retaining components. In some embodiments, the vessel 900 may include pinch points 916 between a first retaining ring 918 and first filter holder 920, and between a second retaining ring 921 and a second filter holder 919. The first retaining ring 918 can engage the first filter holder 920 with the filter media 922 disposed therebetween to retain the filter media 922 in position at a top of the filter. The second retaining ring 921 and the second filter holder 919 can be engaged with the filter media 922 disposed therebetween to retain the filter media 922 in position at the bottom of the filter. This engagement can retain the filter media 922 in position during use.

A cap can be retained on the vessel 900 using clamps or retaining bolts 923 that can be threaded into corresponding holes on a body of the vessel 900. A seal can be disposed between the cap and the body to form a seal for the vessel 900. The engagement of the cap with the body can compress the retaining rings 918, 921, and the filter holders 919, 920. In some embodiments, the first retaining ring 918 can threadedly engage the first filter holder 920, and the second retaining ring 921 can threadedly engage the second filter holder 919 to form a filter assembly. The filter media 922 may be a particular implementation of a filter media, as described above. The vessel 900 may also include a gas inlet valve 924 that may be utilized for directing gas into vessel 900 for drying filter cake on the filter media 922. The gas inlet valve 924 may also be utilized as a vent for pressurized fluid within the vessel 900. A system controller 925 (e.g., a computer system) may include a processor, memory, and display and can be configured to operate the vessel 900 (e.g., opening or closing valves, detecting temperatures and pressures with sensors positioned in vessel 900). System controller 925 may be in signal communication with the vessel 900 (e.g., via a wired or wireless connection such as signal line 926).

During operation of the filter 914, a liquid comprising one or more contaminants can be fed to vessel 900 via feed inlet 904, or optionally, inlet 905. The disposal valve 906 and the gas inlet 924 may remain closed. The vessel 900 may fill up with the liquid to be filtered. During this process and once the vessel 900 is full of the liquid to be filtered, the liquid can flow through the filter media 922 and through the filter 914 and into the flow tube 910. At least a portion of the contaminants in the fluid can be filtered by the filter media 922 and begin to form a filter cake on an exterior surface of the filter media 922, allowing the filtered fluid to pass into the filter. The flow tube 910 may be fluidly coupled to the outlet 902. After entering the flow tube 910, the clean, filtered fluid may exit filter 900 via outlet 902, which can be or can be in fluid communication with, a valve.

FIG. 9B illustrates filter cake 1000 accumulating on the filter media 922. The direction of a flow of liquid is depicted by arrows 1002. The liquid containing the one or more contaminants can enter vessel 900 via the inlet 904, enter the filter 914 (e.g., after passing through the filter media 922 and perforations). After passing through filter 914, the filtered liquid can flow into the flow tube 910 via the inlets 912. The flow tube 910 receives the filtered liquid. The filtered liquid can flow out of the vessel 900 via outlet 902. The flow rate through the vessel 900 can be controlled using one or more control valves and/or through a control of the pumping rate (e.g., the pump speed, etc.). A thickness of filter cake 1000 may correspond with a pressure differential between fluid pressure at inlet 904 and outlet 902, where a thicker filter cake 1000 can be associated with a higher pressure differential. Once the differential pressure is detected to be above a threshold and/or after a threshold time period, the system controller 925 can cease the filtration process.

Once the filtration process is stopped, the self-cleaning cycle can be initiated. As a first step, the vessel 900 can be emptied of the liquid being filtered. FIG. 9C illustrates emptying of liquid from the vessel 900 after filtration is complete. The remaining clean liquid within the flow tube 910 can be directed to the outlet 902 (see arrow 901), and any unfiltered liquid remaining outside of the filter media 922 can be directed back into a feed tank through the feed inlet 904 (see arrows 903). It can be noted that a minor amount of filtered fluid retained in the filter media and/or flow tube 910 may pass back out of the filter media 922 and pass through the feed inlet 904 when the vessel 900 is being drained. A purge gas can be introduced into the vessel 900 via inlet 924 to assist with clearing any remaining fluid within vessel 900. As the gas flows into the vessel 900, any filtered liquid within the flow tube 910 can flows out through outlet 902. Any unfiltered liquid outside of the filter media 922 within the vessel 900 can flow back into a feed tank through the inlet 904. The use of the drain tube 907 can allow the fluid to be removed from slightly above the valve 906. The fluid can be pumped out from the vessel 900 out of the inlet 904 and/or pulled by a suction or vacuum out of the inlet 904. The use of suction along with the drain tube 907 can allow for the vessel 900 to be substantially emptied of liquids before the drying cycle begins. Once empty, the inlet 904 can be closed, for example, using a valve.

Once the vessel 900 is drained, the filter media 922 can have the wet filter cake disposed thereon within the vessel 900. In order to limit the amount of material to be cleaned from the filter media 922, the filter cake can be dried within the vessel 900 before being removed. In order to dry the filter cake 1000, a drying gas can be passed into the vessel 900. FIG. 9D illustrates the filter cake 1000 drying with a drying gas that is pumped into vessel 900 via inlet 924. The gas is utilized to dry filter cake 1000 from filter media 922. The gas may enter flow tube 910 via inlets 912 and may exit vessel 900 via outlet 902. Vessel 900 remains pressurized during drying.

The gas used during the drying cycle can be any suitable gas. In some embodiments, air can be used as the drying gas if oxygen is not reactive with the chemicals in the filter cake. Otherwise, an inert gas such as nitrogen can be used. In order to dry the filter cake, the gas can be heated and/or dried prior to passing into the vessel 900. For example, the gas can be heated to between 5° C. and 95° C. prior to passing into the vessel 900. The temperature of the gas will depend on the materials used to form the filter and housing and/or the type of chemicals being filtered within the vessel 900. The use of a heated and/or dried gas may improve the drying times for the filter cake.

Once dried, the filter cake 1000 can be removed from the filter media 922. FIG. 9E illustrates the filter cake 1000 being removed from the filter media 922. In order to remove the dried filter cake from the filter media 922, the flow of the drying gas can be stopped. Any remaining gas pressure can be released via outlet 902. Depending on the gas composition, a purge gas can be optionally used to purge the vessel 900 if needed. The valve 906 can be opened in order to collect the dried filter cake when removed from the filter media 922. When removed, the pieces of the filter cake 1000 can fall from the filter media 922 and pass through the valve 906 (open position) for collection and subsequent disposal.

In order to remove the dried filter cake from the filter media 922, a back-pulse of a gas can be used to expand the filter media 922. The back-pulse can be provided by a gas source such as a compressed gas source (e.g., a pressure tank, etc.), a compressor, a fan, a blower, or the like. FIG. 9F illustrates a flow of gas entering the vessel 900 via the outlet 902 depicted by arrows 1004. This back pulse flow of gas causes the filter media 922 to be restored to the original shape as discussed herein. For example, the filter media 922 may conform to the shape of the tube(s) and/or spacers as described above during the filtration process. The filter cake can also conform to the shape of the filter media 922 during the filtration process. By back-pulsing the filter media 922, the filter media 922 can expand outward and change shape. The change in shape may cause the dried filter cake to break into pieces and become dislodged from the filter media 922.

The amount of the gas used for the back-pulse can depend on the need to provide a pressure differential within the interior of the filter media 922. As the volume within the filter assembly increases, a large amount of gas is needed in order to provide a given amount of pressure differential, which would need to be supplied by a larger gas reservoir (e.g., a pressure tank, etc.), fan, compressor, or the like. This can lead to a correspondingly larger compressor and associated equipment. In order to reduce the amount of gas needed for the back-pulse, a core or volume reducer as described herein can be used. The core or volume reducer can reduce the total amount of space or volume that needs to be pressurized with the gas in order to back-pulse the filter media 922. This can then reduce the size of the equipment needed to provide the back-pulse.

Once dislodged, the dried filter cake pieces can then pass downwards through the valve 906 into a receptacle. After this back pulse flow of gas, the filtration and cleaning process is complete, and the valve 906 can be closed. Vessel 900 may be ready for a subsequent filtration cycle for another batch of contaminated liquid. Thus, the self-cleaning cycle can be used to reduce the total amount of waste generated from the system by drying the filter cake within the vessel so that only a dried filter cake is removed from the system. Further, the filter cake can be removed without the need for the removal of the entire self-cleaning filter assembly and without requiring users to handle the wet, and potentially harmful, filter cake materials.

Within the system illustrated in FIG. 9A-9F, a filtering system can comprise a plurality of vessels 900 arranged in parallel. This allows the system to continue to filter the liquids through at least one vessel 900 while one or more additional vessels are placed into the self-cleaning process. In some embodiments, a filtering system can comprise 2-10 vessels, with at least 2 vessels fluidly connected in parallel.

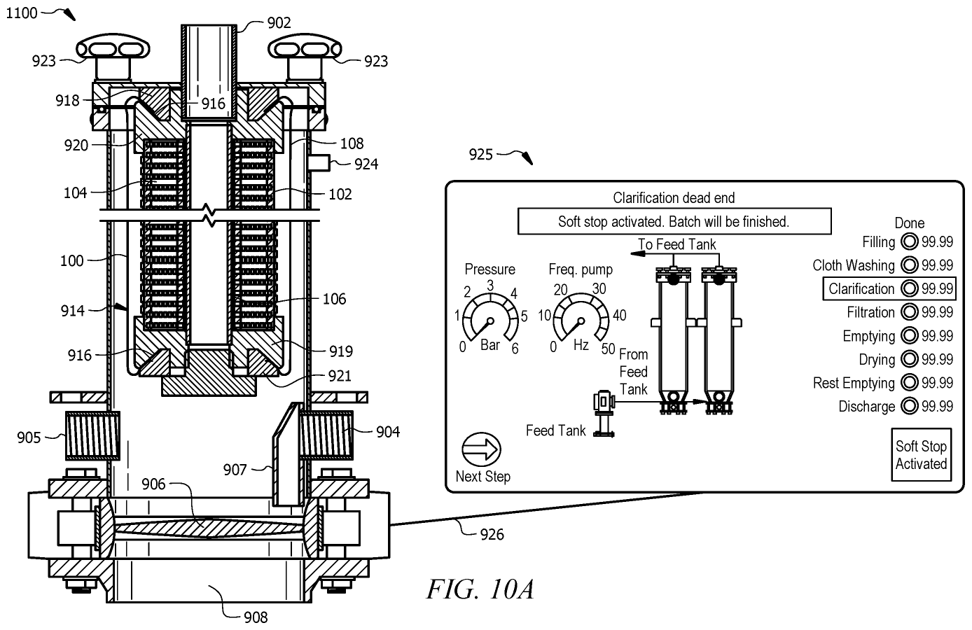

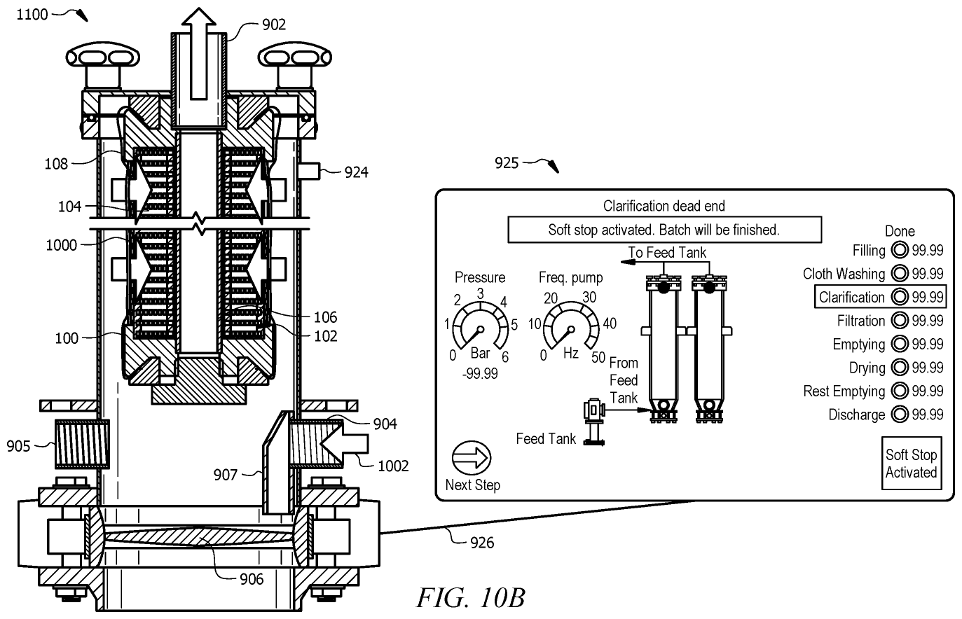

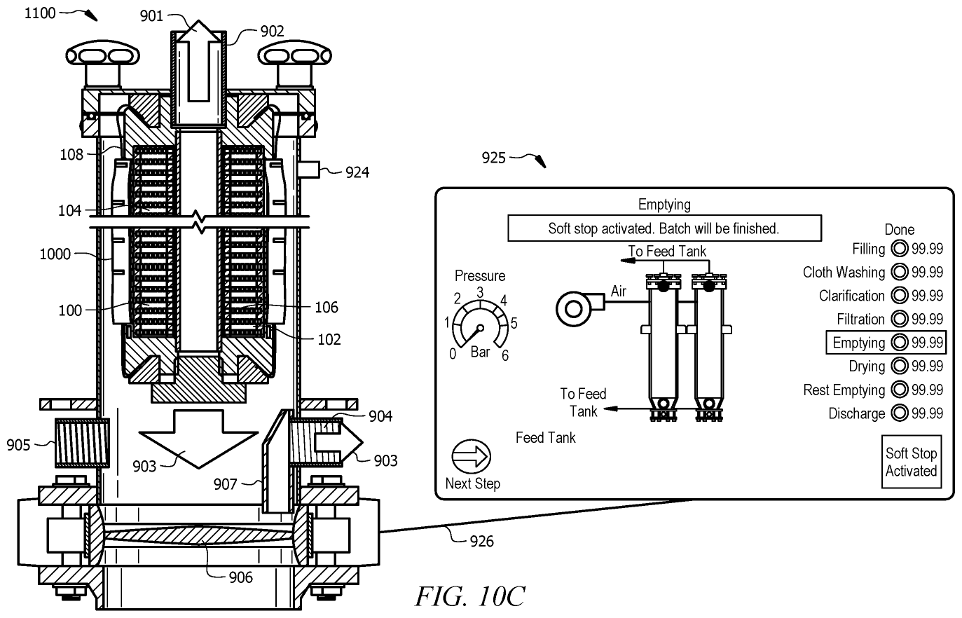

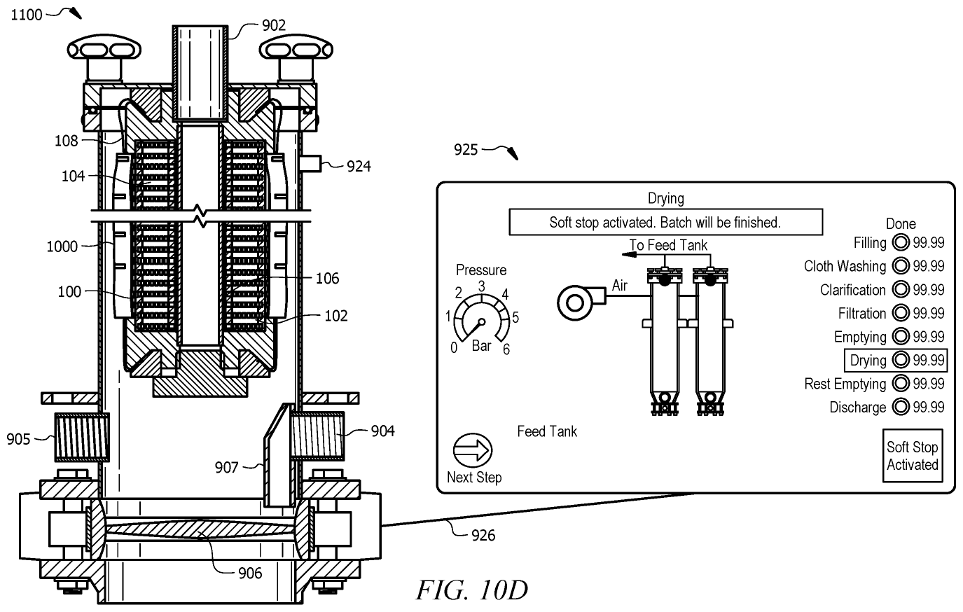

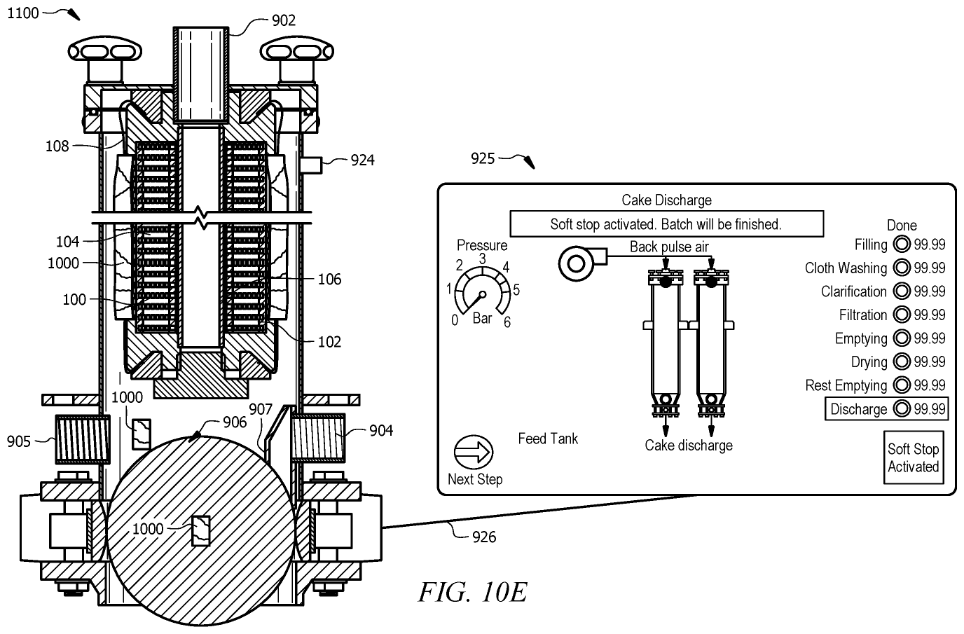

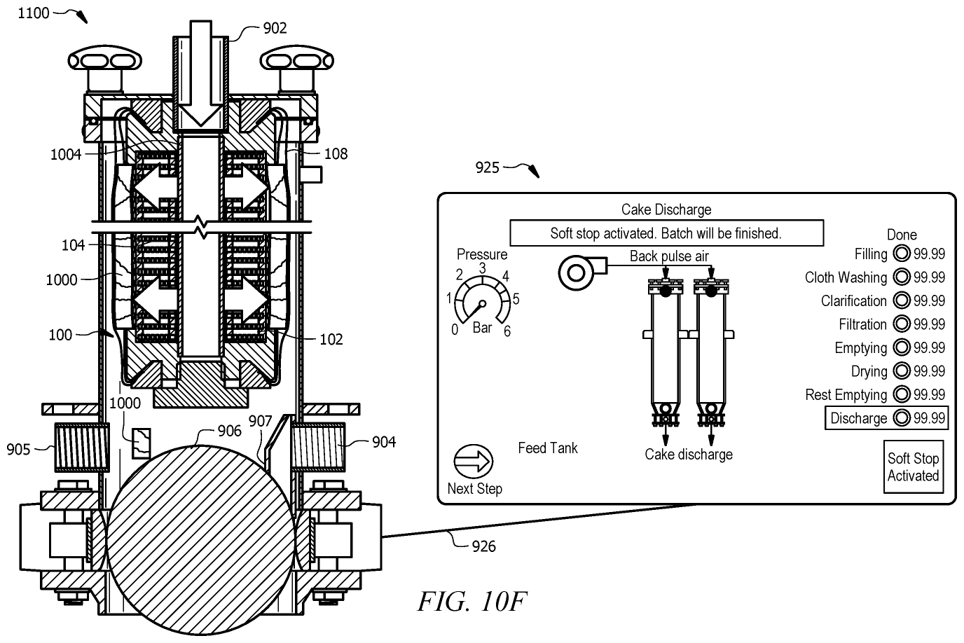

Another embodiment of a filtering system is shown in FIGS. 10A-10F. FIG. 10A illustrates a filtering vessel 1100, which can be similar to the vessel 900. The vessel 1100 may be formed from metals or alloys (e.g., steel, stainless steel, etc.), a composite material, polymers (e.g. polypropylene, polyvinylidene fluoride (PVDF), etc.), polymer coated or lined metal (e.g., a rubber lined vessel), or the like and can be configured to withstand high pressures and high temperatures during filtering operations. The vessel 1100 may be a sealed vessel except for the filtrate outlet 902 at a first end (top) of the vessel 1100, a feed inlet 904 at a second end (bottom), and a filter cake disposal valve 906. A filter cake discharge chute 908 may be adjacent (below) to the valve 906. The vessel 1100 may include a self-cleaning filter including any of those described herein. The vessel 1100 may include a chamber 106 for receiving filtered fluid. In some embodiments, the filter may not include a flow tube to collect fluids from a lower portion of the filter to pass the fluids out of the filtrate outlet 902.

The vessel 1100 may include the filter media coupled in the same manner as described with respect to the vessel 900. The vessel 1100 may also include gas inlet 924, which can be coupled to a valve, that may be utilized for directing gas into the vessel 1100 for drying the filter cake on the filter media 108. The gas inlet 924 may also be utilized as a vent for pressurized fluid within the vessel 1100 in portions of the filtering and/or self-cleaning cycles. A system controller 925 (e.g., a computer system as described in more detail herein) may include a display and can be configured to operate the vessel 1100 (e.g., opening or closing valves, detecting temperatures and pressures with sensors positioned in the vessel 1100).

During operation of the filter system, a liquid comprising one or more contaminants can be fed to the vessel 1100 via the feed inlet 904. The disposal valve 906 and the gas inlet 924, and optional inlet 905, may remain closed during the filtration process. In some embodiments, the gas inlet 924 can optionally be used to vent any gas in the vessel 1100 while the vessel 1100 is initially filling. The vessel 1100 may fill up completely with the liquid to be filtered, including a portion of the liquid that passes through the filter media to fill the filter.

After the vessel 1100 is full of liquid to be filtered, the liquid can be circulated through the vessel 1100 such that the liquid flows through filter and into the chamber 106. The chamber 106 may be fluidly coupled to the outlet 902. After entering the chamber 106, clean fluid may exit the vessel 1100 via the outlet 902. The flow of fluid can be controlled by an outlet valve, a pumping speed (e.g., thereby controlling the pump speed), or a combination thereof.

During the filtration process, a filter cake 1000 can form on an outer surface of the filtration medium. FIG. 10B illustrates the filter cake 1000 accumulating on the filter media 108. The direction of a flow of the liquid is depicted by the arrows 1002. The contaminated liquid enters the vessel 1100 via the inlet 904 and/or optional inlet 905, enters the filter (passing through filter media 108 and perforations 104). After passing into the filter, the liquid is clean (e.g. having at least a portion of the contaminants removed by being filtered) and can flow into the chamber 106 via perforations 104 and filter media 108. The chamber 106 receives the filtered liquid. The filtered liquid can flow out of the vessel via the outlet 902. A thickness of filter cake 1000 may correspond with a pressure differential between fluid pressure at inlet 904 and outlet 902. The thicker the filter cake 1000 is, the larger the pressure differential may be across the filter cake and filtration media. Once a threshold differential pressure is detected and/or after a threshold time period occurs, for example as detected by a system controller 925, the filtration process can be halted.

Once the filtration process is halted, the self-cleaning cycle can be initiated. The self-cleaning cycle can begin by draining the liquid from the vessel 1100. FIG. 10C illustrates the emptying of the liquid from the vessel 1100 after filtration is complete. The liquid remaining in the vessel 1100 can be directed back into a feed tank through the feed inlet 904 (see arrow 903). A purging gas may flow into the vessel 1100 via the inlet 924 to assist with clearing any remaining fluid within the vessel 1100. As the gas flows into the vessel 1100, the remaining liquid can flow back into a feed tank through inlet 904. A drain tube 907 can be used to allow the fluid to be drained down to the top of the valve 906 using pressure within the vessel 1100 and or suction from the inlet 904. Once empty, an inlet valve coupled to the inlet 904 can be closed.

The vessel can then contain the filter cake 1000 on the filter media. FIG. 10D illustrates the filter cake 1000 being dried with a drying gas that is passed into the vessel 1100 via the inlet 924. The drying gas is utilized to dry the filter cake 1000 on the filter media 108. The drying gas may enter the chamber 106 via the perforations 104 and may exit the filter 1100 via the outlet 902. FIG. 10E illustrates the dried filter cake 1000 on the filter media 108. As shown, the filter cake can start to crack based on shrinkage as the filter cake dries.

Once dried, the filter cake can be removed from the filter media via one or more back-pulses of gas. FIG. 10F illustrates a flow of gas entering the vessel 1100 via the outlet 902 depicted by the arrows 1004. This back pulse flow of gas can cause the filter media to expand and dislodge the filter cake 1000 from the filter media 108 after the drying of filter cake 1000. The dried filter cake can then break off and pass through the valve 906 for collection and disposal. After this back pulse flow of gas, the filtration and cleaning process is complete. Vessel 1100 may be ready for a subsequent filtration cycle for another batch of contaminated liquid.

Having described various systems and methods herein, some embodiments can include, but are not limited to:

In a first embodiment, a filter comprises: a tube comprising perforations, the tube configured to receive a flow of a liquid from a first direction or a flow of a gas from a second direction opposite to the first direction; a filter media positioned concentrically around the tube; and one or more spacers positioned between the tube and the filter media to create a space between the tube and the filter media; wherein a portion of the filter media is configured to flex inward into the space during the flow of the liquid into the filter, and flex outward from the space during the flow of the gas exiting the filter.

A second embodiment can include the filter of the first embodiment, further comprising: a reinforcement core positioned within the tube, wherein the reinforcement core at least partially extends along a length of the tube and includes portions to support the tube and prevent deformation of the tube.

A third embodiment can include the filter of the second embodiment, wherein the reinforcement core includes recesses configured to receive filtrate.

A fourth embodiment can include the filter of any one of the first to third embodiments, further comprising: a volume reducer positioned within the tube, wherein the volume reducer includes an internal chamber and extends at least partially along a length of the tube, wherein the internal chamber is configured to not receive filtrate.

A fifth embodiment can include the filter of the fourth embodiment, wherein a passage extends through the volume reducer, wherein the passage is configured to receive filtrate.

In a sixth embodiment, a filter comprises: a plurality of tubes, each tube comprising perforations and each tube configured to receive a flow of a liquid from a first direction or a flow of a gas from a second direction opposite to the first direction; and a filter media positioned concentrically around the plurality of tubes to form a space between adjacent tubes of the plurality of tubes and a portion of the filter media; wherein the portion of the filter media is configured to flex inward into the space during the flow of the liquid into the filter, and flex outward from the space during the flow of the gas exiting the filter.

A seventh embodiment can include the filter of the sixth embodiment, wherein one or more tubes of the plurality of tubes comprises a reinforcement core positioned within the tube, wherein the reinforcement core at least partially extends along a length of the tube and comprises portions configured to support the tube and prevent deformation of the tube.

An eighth embodiment can include the filter of the seventh embodiment, wherein the reinforcement core comprises recesses to receive filtrate.

A ninth embodiment can include the filter of any one of the sixth to eighth embodiments, further comprising: a volume reducer positioned between the plurality of tubes, wherein the volume reducer includes an internal chamber and extends along a length of the tubes, wherein the internal chamber is configured to not receive filtrate.

A tenth embodiment can include the filter of the ninth embodiment, wherein a passage extends through the volume reducer, wherein the passage is configured to receive filtrate.

An eleventh embodiment can include the filter of any one of the sixth to tenth embodiments, further comprising a passage extending at least partially along lengths of the tubes, wherein the passage is positioned between the tubes, wherein the passage is configured to receive filtrate.

In a twelfth embodiment, a method of filtering a fluid comprises: receiving a liquid in a vessel including a filter; receiving the liquid in the filter from a first direction, wherein the filter comprises: a tube including perforations; a filter media positioned concentrically around the tube; and one or more spacers positioned between the tube and the filter media, wherein a space is created between the tube and the filter media when the liquid is received from the first direction; flexing a portion of the filter media inward into the space upon receipt of the liquid; accumulating a filter cake on the filter media in response to receiving the liquid in the filter from the first direction; receiving a gas in the filter from a second direction opposite to the first direction; flexing the portion of the filter media outwards from the space upon receipt of the gas; and removing the filter cake from the filter media based on flexing the portion of the filter media outwards.

A thirteenth embodiment can include the method of the twelfth embodiment, further comprising: drying the filter cake with the gas.

A fourteenth embodiment can include the method of the thirteenth embodiment, wherein the filter further comprises: a reinforcement core positioned within the tube, wherein the reinforcement core at least partially extends along a length of the tube and includes portions to support the tube and prevent deformation of the tube.

A fifteenth embodiment can include the method of the fourteenth embodiment, wherein the reinforcement core includes recesses to receive filtrate.

A sixteenth embodiment can include the method of any one of the thirteenth to fifteenth embodiments, wherein the filter further comprises: a volume reducer positioned within the tube, wherein the volume reducer includes an internal chamber and extends at least partially along a length of the tube, wherein the internal chamber does not receive filtrate.

In a seventeenth embodiment, a method comprises: receiving a liquid in a vessel including a filter; receiving the liquid in the filter from a first direction, wherein the filter comprises: a plurality of tubes, each tube comprising perforations; and a filter media positioned concentrically around the tubes to form a space between two tubes and a portion of the filter media; flexing the portion of the filter media inward into the space upon receipt of the liquid; accumulating a filter cake with the filter media; receiving a gas in the filter from a second direction opposite to the first direction; flexing the portion of the filter media outwards from the space upon receipt of the gas; and removing at least a portion of the filter cake from the filter media in response to flexing the portion of the filter media outwards.

An eighteenth embodiment can include the method of the seventeenth embodiment, further comprising: drying the filter cake with the gas.

A nineteenth embodiment can include the method of the eighteenth embodiment, wherein the filter further comprises: a reinforcement core positioned within each tube, wherein the reinforcement core at least partially extends along a length of each tube and includes portions to support each tube and prevent deformation of each tube.

A twentieth embodiment can include the method of any one of the seventeenth to nineteenth embodiments, wherein the filter further comprises: a volume reducer positioned within each tube, wherein the volume reducer includes an internal chamber and extends at least partially along a length of each tube, wherein the internal chamber does not receive filtrate.

A twenty first embodiment can include the method of any one of the seventeenth to twentieth embodiments, further comprising: a volume reducer positioned between the plurality of tubes, wherein the volume reducer includes an internal chamber and extends along a length of the tubes, wherein the internal chamber is configured to not receive filtrate.

A twenty second embodiment can include the method of the twenty first embodiment, wherein a passage extends through the volume reducer, wherein the passage is configured to receive filtrate.

The particular embodiments disclosed above are illustrative only, as the embodiments may be modified and practiced in different manners apparent to those skilled in the art having the benefit of the teachings herein. It is therefore evident that the particular embodiments disclosed above may be altered or modified and all such variations are considered within the scope of the present disclosure.

What is claimed is:

1. A filter comprising:
a tube comprising perforations, the tube configured to receive a flow of a liquid from a first direction or a flow of a gas from a second direction opposite to the first direction;
a filter media positioned concentrically around the tube; and
one or more spacers positioned between the tube and the filter media to create a space between the tube and the filter media;
wherein a portion of the filter media is configured to flex inward into the space during the flow of the liquid into the filter, and flex outward from the space during the flow of the gas exiting the filter.

2. The filter of claim 1, further comprising: a reinforcement core positioned within the tube, wherein the reinforcement core at least partially extends along a length of the tube and includes portions to support the tube and prevent deformation of the tube.

3. The filter of claim 2, wherein the reinforcement core includes recesses configured to receive filtrate.

4. The filter of claim 1, further comprising: a volume reducer positioned within the tube, wherein the volume reducer includes an internal chamber and extends at least partially along a length of the tube, wherein the internal chamber is configured to not receive filtrate.

5. The filter of claim 4, wherein a passage extends through the volume reducer, wherein the passage is configured to receive filtrate.

6. A filter comprising:
a plurality of tubes, each tube comprising perforations and each tube configured to receive a flow of a liquid from a first direction or a flow of a gas from a second direction opposite to the first direction; and
a filter media positioned concentrically around the plurality of tubes to form a space between adjacent tubes of the plurality of tubes and a portion of the filter media;
wherein the portion of the filter media is configured to flex inward into the space during the flow of the liquid into the filter, and flex outward from the space during the flow of the gas exiting the filter.

7. The filter of claim 6, wherein one or more tubes of the plurality of tubes comprises a reinforcement core positioned within the tube, wherein the reinforcement core at least partially extends along a length of the tube and comprises portions configured to support the tube and prevent deformation of the tube.

8. The filter of claim 7, wherein the reinforcement core comprises recesses to receive filtrate.

9. The filter of claim 6, further comprising: a volume reducer positioned between the plurality of tubes, wherein the volume reducer includes an internal chamber and extends along a length of the tubes, wherein the internal chamber is configured to not receive filtrate.

10. The filter of claim 9, wherein a passage extends through the volume reducer, wherein the passage is configured to receive filtrate.

11. The filter of claim 6, further comprising a passage extending at least partially along lengths of the tubes, wherein the passage is positioned between the tubes, wherein the passage is configured to receive filtrate.

12. A method of filtering a fluid, the method comprising:
receiving a liquid in a vessel including a filter;
receiving the liquid in the filter from a first direction, wherein the filter comprises:
a tube including perforations;
a filter media positioned concentrically around the tube; and
one or more spacers positioned between the tube and the filter media, wherein a space is created between the tube and the filter media when the liquid is received from the first direction;
flexing a portion of the filter media inward into the space upon receipt of the liquid;
accumulating a filter cake on the filter media in response to receiving the liquid in the filter from the first direction;
receiving a gas in the filter from a second direction opposite to the first direction;
flexing the portion of the filter media outwards from the space upon receipt of the gas; and
removing the filter cake from the filter media based on flexing the portion of the filter media outwards.

13. The method of claim 12, further comprising: drying the filter cake with the gas.

14. The method of claim 13, wherein the filter further comprises: a reinforcement core positioned within the tube, wherein the reinforcement core at least partially extends along a length of the tube and includes portions to support the tube and prevent deformation of the tube.

15. The method of claim 14, wherein the reinforcement core includes recesses to receive filtrate.

16. The method of claim 13, wherein the filter further comprises: a volume reducer positioned within the tube, wherein the volume reducer includes an internal chamber and extends at least partially along a length of the tube, wherein the internal chamber does not receive filtrate.

17. A method comprising:
receiving a liquid in a vessel including a filter;
receiving the liquid in the filter from a first direction, wherein the filter comprises:
a plurality of tubes, each tube comprising perforations; and
a filter media positioned concentrically around the tubes to form a space between two tubes and a portion of the filter media;
flexing the portion of the filter media inward into the space upon receipt of the liquid;
accumulating a filter cake with the filter media;
receiving a gas in the filter from a second direction opposite to the first direction;
flexing the portion of the filter media outwards from the space upon receipt of the gas; and
removing at least a portion of the filter cake from the filter media in response to flexing the portion of the filter media outwards.

18. The method of claim 17, further comprising: drying the filter cake with the gas.

19. The method of claim 18, wherein the filter further comprises: a reinforcement core positioned within each tube, wherein the reinforcement core at least partially extends along a length of each tube and includes portions to support each tube and prevent deformation of each tube.

20. The method of claim 17, wherein the filter further comprises: a volume reducer positioned within each tube, wherein the volume reducer includes an internal chamber and extends at least partially along a length of each tube, wherein the internal chamber does not receive filtrate.

21. The method of claim 17, further comprising: a volume reducer positioned between the plurality of tubes, wherein the volume reducer includes an internal chamber and extends along a length of the tubes, wherein the internal chamber is configured to not receive filtrate.

22. The method of claim 21, wherein a passage extends through the volume reducer, wherein the passage is configured to receive filtrate.
